(19) United States
(12) Patent Application Publication
(10) Pub. No.: US 2026/0263327 A1
(43) Pub. Date: Sep. 10, 2026

(54) Breast Mold Pacifier

(71) Applicant: Taylen Orrino, Granite Falls, WA (US)

(72) Inventor: Taylen Orrino, Granite Falls, WA (US)

(21) Appl. No.: 19/071,606

(22) Filed: Mar. 5, 2025

(51) Int. Cl. A61J 17/00

(52) U.S. Cl. CPC A61J 17/109; A61J 17/105; A61J 17/111

(57) ABSTRACT

A pacifier made with a molded breast including a nipple and an areola includes a silicon insert to simulate lobules in the molded breast. A substrate for the molded breast simulates fatty breast tissue and comprises attachment apertures to hook up with a pacifier base having the molded breast and substrate via attachments posts complementary to the attachment apertures.

### BACKGROUND

Pacifiers and teething accessories are a go-to for parents/caregivers desiring to soothe an infant; yet, due to size it is very common for them to get lost over time and misplacing them is often prevalent when traveling. This can be incredibly frustrating for parents especially in times where a pacifier or teething accessory is needed, but is nowhere to be found. There have been no products available as original equipment or as an aftermarket to address this problem.

An apparatus that helps soothe infants when teething that is easy to locate and not lose is not being met by any known device or system at present. There have been no products available as original equipment or as an aftermarket to address this problem either.

### SUMMARY OF THE INVENTION

A pacifier made with a molded breast including a nipple and an areola includes a silicon insert to simulate lobules in the molded breast. A substrate for the molded breast simulates fatty breast tissue and comprises attachment apertures to hook up with a pacifier base having the molded breast and substrate via attachments posts complementary to the attachment apertures.

### BRIEF DESCRIPTION OF THE DRAWINGS

FIG. 1 is a side view of a plastic insert for the breast mold in accordance with an embodiment of the present disclosure.

FIG. 2 is a side view of the components of the breast mold pacifier in accordance with an embodiment of the present disclosure.

FIG. 3 is a top view of the molded breast in accordance with an embodiment of the present disclosure.

FIG. 4 is a bottom view of the molded breast and the substrate in accordance with an embodiment of the present disclosure.

FIG. 5 is a top view of the pacifier base in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

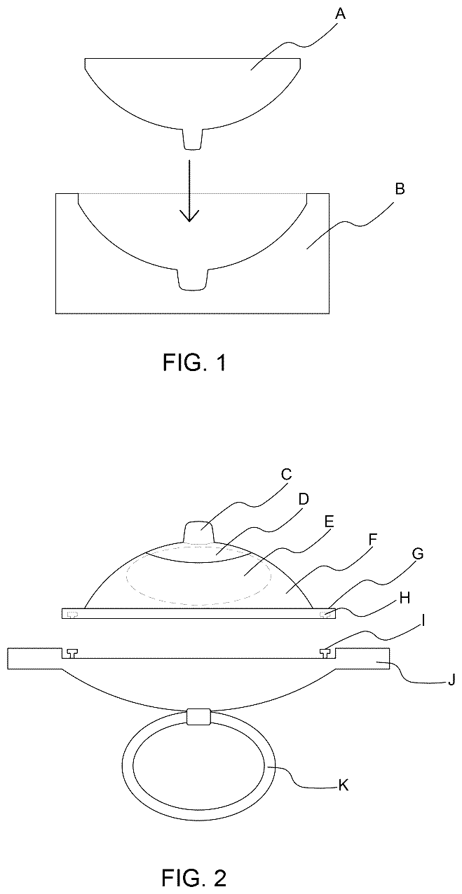

FIG. 1 is a side view of a plastic insert for the breast mold in accordance with an embodiment of the present disclosure. The plastic insert A represents a human breast. The breast mold B is complementary to the plastic insert A by form and by function. They are made together and come in a kit for a do it yourself custom made pacifier as disclosed herein.

FIG. 2 is a side view of the components of the breast mold pacifier in accordance with an embodiment of the present disclosure. The view includes the BPA free silicone nipple C, the areola D, the silicone insert E, the molded BPA free silicone breast F as a one piece with the substrate G. The substrate G alternatively receives the molded breast F in a two-piece clipping arrangement. The substrate G includes attachment apertures or slits therein to connect with attachment posts I in the pacifier base J. A pacifier puller ring K is attached to the pacifier base as a means for inserting and removing the breast mold pacifier. A diameter of the molded breast F is smaller than a diameter of the substrate G which is smaller than a diameter of the pacifier base J. In other words, a diameter of the pacifier base J is larger than a diameter of the substrate G which in turn is larger than a diameter of the molded breast F.

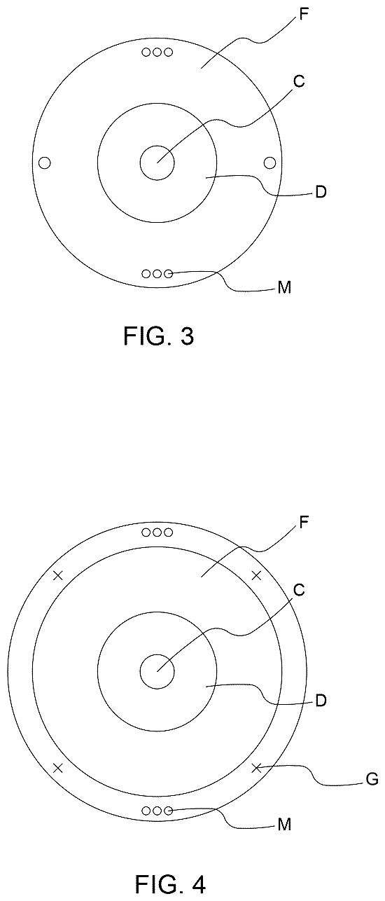

FIG. 3 is a top view of the molded breast in accordance with an embodiment of the present disclosure. The view includes the nipple C, the areola D, the molded breast F, and air holes M.

FIG. 4 is a bottom view of the molded breast and the substrate in accordance with an embodiment of the present disclosure. The view includes the nipple C, the areola D, the molded breast F, the air holes M and the attachment apertures or slits G.

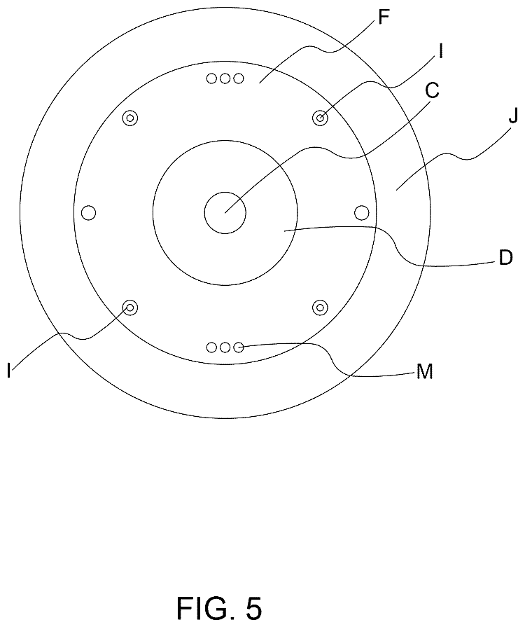

FIG. 5 is a top view of the pacifier base in accordance with an embodiment of the present disclosure. The view includes the nipple D, the areola D, the molded breast F, the air holes M and the attachment posts I and the pacifier base J. A diameter of the molded breast F is smaller than a diameter of the substrate G which is smaller than a diameter of the pacifier base J. In other words, a diameter of the pacifier base J is larger than a diameter of the substrate G which in turn is larger than a diameter of the molded breast F,

Embodiments of the disclosure include a breast mold. herein the molded breast is shaped from the breast mold air holes for a movement of the molded breast against the substrate. Also, the nipple, the areola, and the molded breast comprises a silicon of varying colors. The silicon insert also includes ducts which collapse under a suction force. The substrate comprises a polyurethane foam. Embodiments of the molded breast include a rubbery latex and the silicon insert filled with a liquid gel. The pacifier is also imprinted with a skin texture.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

What is claimed is:

1. A pacifier comprising:
a molded breast comprising a nipple, an areola and configured to define a silicon insert to simulate lobules in the molded breast;
a substrate for the molded breast configured to simulate a fatty tissue and a chest wall for the molded breast and to comprise attachment apertures; and
a pacifier base configured to receive the molded breast and substrate via attachments posts complementary to the attachment apertures.

2. The pacifier of claim 1, further comprising a breast mold.

3. The pacifier of claim 2, wherein the molded breast is shaped from the breast mold.

4. The pacifier of claim 1, wherein the substrate further defines air holes for a movement of the molded breast against the substrate.

5. The pacifier of claim 1, wherein the nipple and the areola comprise a custom insert of varying colors.

6. The pacifier of claim 1, wherein the molded breast comprises a silicon of varying colors.

7. The pacifier of claim 1, wherein the silicon insert comprises ducts which collapse under a suction force.

8. The pacifier of claim 1, wherein the pacifier base comprises a puller ring configured for insertion and removal of the pacifier.

9. The pacifier of claim 1, wherein the substrate comprises a polyurethane foam.

10. The pacifier of claim 1, wherein the pacifier base has a diameter larger than a diameter of the substrate which has a diameter larger than a diameter of the molded breast.

11. The pacifier of claim 1, wherein the molded breast is a rubbery latex and the silicon insert is filled with a liquid gel.

12. The pacifier of claim 1, wherein the pacifier is imprinted with a skin texture.
